(19) United States
(12) Patent Application Publication
(10) Pub. No.: US 2003/0057144 A1
(43) Pub. Date: Mar. 27, 2003

(54) Automatic sorting compression machine for iron, aluminum cans and plastic bottles

(76) Inventor: Tu-Mu Wang, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/963,031

(22) Filed: Sep. 26, 2001

(51) Int. Cl. B07C 5/344; B30B 15/30

(52) U.S. Cl. 209/636; 209/523; 209/571; 209/213; 209/907; 100/902; 100/215

(57) ABSTRACT

The present invention relates to an automatic sorting compression machine for iron, aluminum cans and plastic bottles. An inlet is provided atop the main body of the present invention. At least one detecting switch is arranged in a preset position of the inlet. A receptacle is disposed under the inlet. A one-way outlet and a two-way outlet are fitted at the front and rear ends of the receptacle. An exit selector controlled by a change-over magnetic valve is disposed at the two-way outlet. A container is placed under each of the three channels of the outlets. The press shaft of a spindle passes through the receptacle. The press shaft is fitted with an electrified magnet and an electrified pole at the front end thereof while another electrified pole opposite to the electrified pole is mounted in preset position of the main body. A microswitch is disposed in the farthest position of the press shaft being drawn back. The detecting switch and the microswitch 24 are used to start or stop the operation of the spindle.

### BACKGROUND OF THE INVENTION

1. Field of the Invention

The present invention relates to an automatic sorting compression machine for iron, aluminum cans and plastic bottles, and more particularly, to a device by which the sorting work and the storage room can be significantly reduced to facilitate the recycling.

2. Description of the Prior Art

The iron, aluminum cans and plastic bottles are the most common containers for drinks. The conventional compression machine for recycled cans is only able to sort the iron and aluminum cans while the plastic bottles can't be sorted out. Therefore, the three most common containers can't be sorted at the same time for facilitating the recycling procedure. Additional procedure through manual sorting has to be carried out for completing the sorting and compressing tasks.

### SUMMARY OF THE INVENTION

It is a primary object of the present invention to provide an automatic sorting compression machine for iron, aluminum cans and plastic bottles by which the plastic bottles are sorted out by means of the electrical conductivity while the iron and aluminum cans are sorted out by means of the magnetic attraction. Meanwhile, they are compressed. Thus, the sorting work and the storage room can be significantly reduced to facilitate the recycling work.

It is another object of the present invention to provide an automatic sorting compression machine for iron, aluminum cans and plastic bottles which is small in volume and won't occupy much room. Moreover, the operation thereof is easy and convenient.

It is a further object of the present invention to provide an automatic sorting compression machine for iron, aluminum cans and plastic bottles whose malfunction is reduced to the minimum so that the safety of the user is also ensured.

### BRIEF DESCRIPTION OF THE DRAWINGS

The accomplishment of this and other objects of the invention will become apparent from the following description and its accompanying drawings of which:

FIG. 1 is a schematic drawing of an applicable embodiment of the present invention (before compressing);

FIG. 2 is another schematic drawing of the applicable embodiment of the present invention (after compressing);

FIG. 3 is a sectional view taken along the line A-A of FIG. 1;

FIG. 4 is an operating and sorting flow chart of the applicable embodiment of the present invention;

FIG. 5 is a schematic drawing of the applicable embodiment of the present invention provided with a protecting cover atop an inlet;

FIG. 6 is a perspective view of another applicable embodiment of the present invention;

FIG. 7 is a schematic drawing of another applicable embodiment of the present invention; and

FIG. 8 is a sectional view taken along the line B-B of FIG. 7.

### DETAILED DESCRIPTION OF THE PREFERRED EMBODIMENT

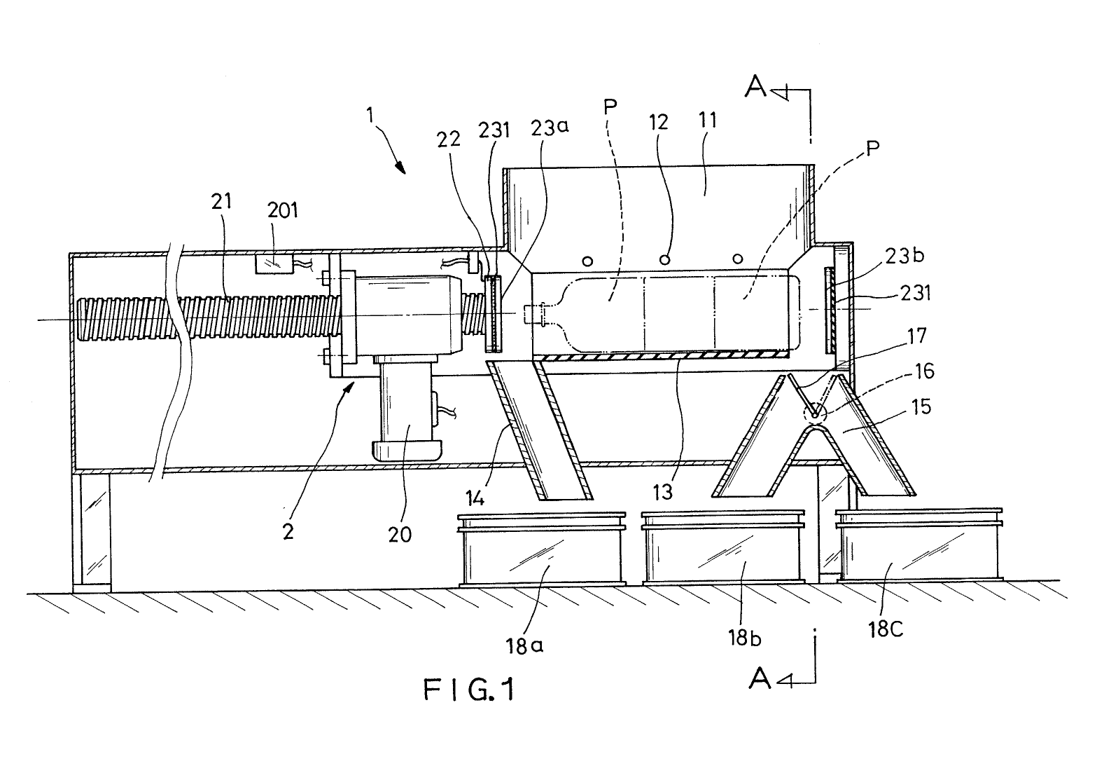

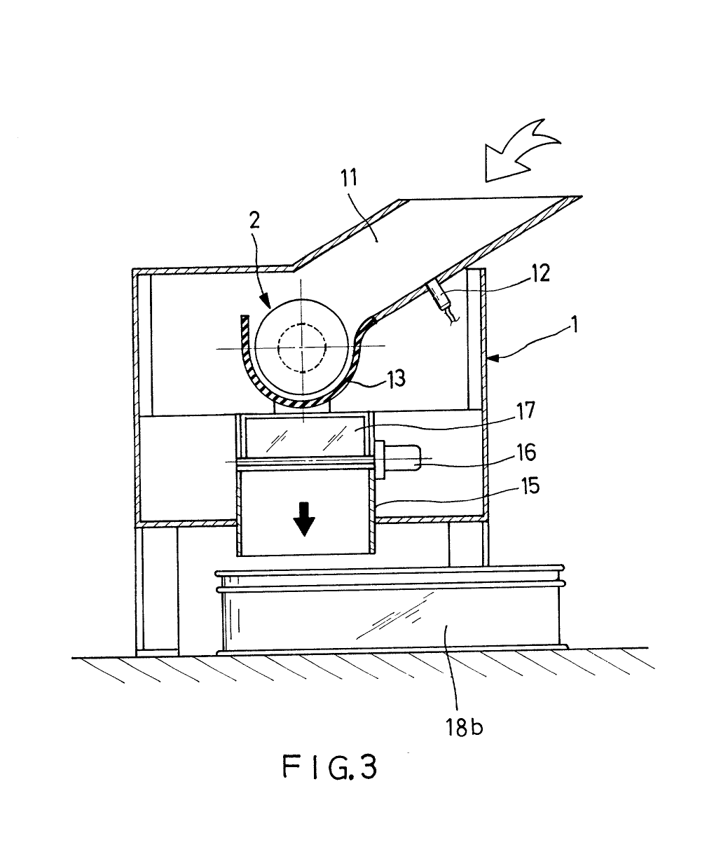

First of all, referring to FIGS. 1 through 4, an inlet 11 is provided atop the main body 1 of the present invention. At least one detecting switch 12 is arranged in a preset position of the inlet 11. A receptacle 13 is disposed under the inlet 11. A one-way outlet 14 and a two-way outlet 15 are fitted at the front and rear ends of the receptacle 13. An exit selector 17 controlled by a change-over magnetic valve 16 is disposed at the two-way outlet 15. A container 18a, 18b, 18c is placed under each of the three channels of the outlets 14, 15. The press shaft 21 of a spindle 2 passes through the receptacle 13. The press shaft 21 is fitted with an electrified magnet 22 and an electrified pole 23a at the front end thereof while another electrified pole 23b opposite to the electrified pole 23a is mounted in preset position of the main body 1. A microswitch 24 is disposed in the farthest position of the press shaft 21 being drawn back. The detecting switch 12 and the microswitch 24 are used to start or stop the operation of the spindle 2.

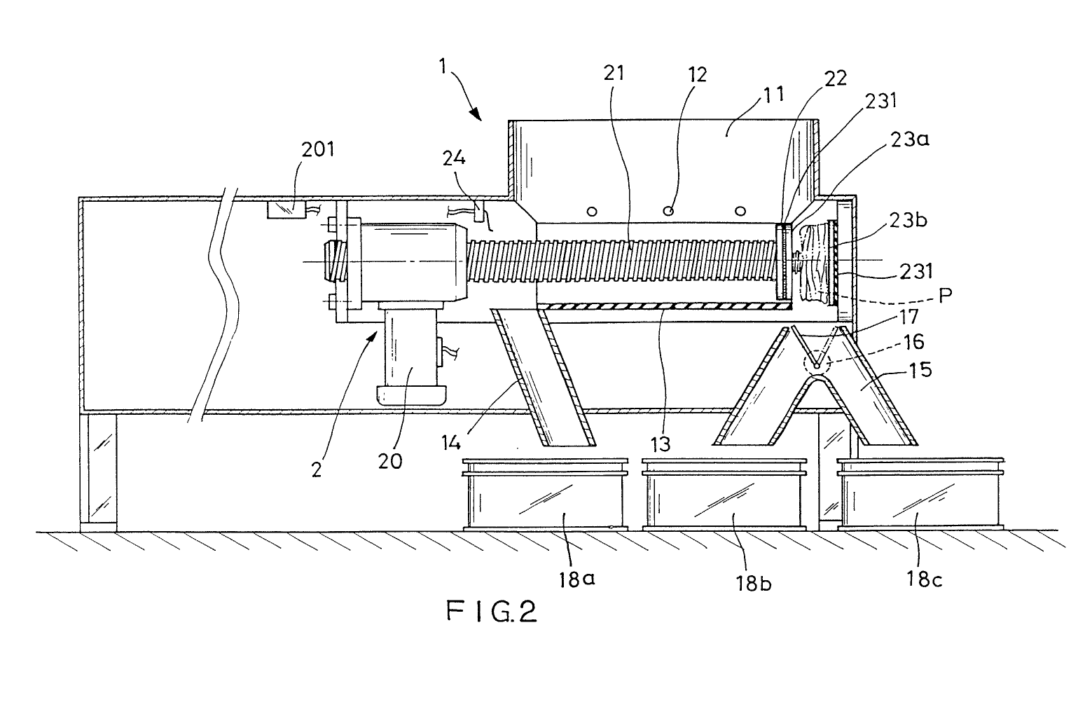

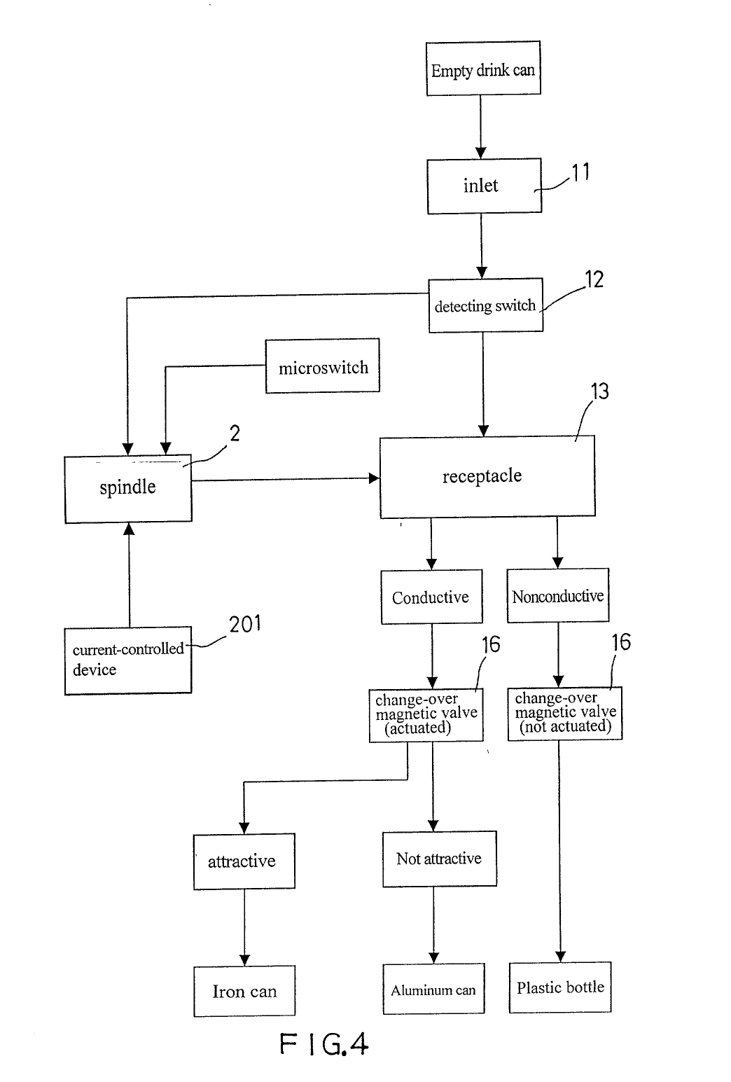

Based on the aforementioned, when a can is fed through the inlet 11 into the present invention, the detecting switch 12 will be touched so that the can falls into the receptacle 13. The actuating signal of the detecting switch 12 enables the operation of the spindle 2 so that the press shaft 21 is moved forward. While the can is compressed, the electrified poles 23a, 23b will check if it the compressed can is electrically conductive. If it is nonconductive, it will be regarded as a plastic bottle. Moreover, the change-over magnetic valve 16 won't be actuated and the exit selector 17 is sloping leftward so that the compressed plastic bottle falls into the right container 18c, as shown in FIGS. 1 and 2. If it is conductive, the compressed can is metallic (iron or aluminum) can. At this time, the change-over magnetic valve 16 is actuated to enable the exit selector 17 to slope rightward. Accordingly, the exit direction of the two-way outlet 15 is changed. Meanwhile, the compressed can will be checked by the electrified magnet 22 if it has the magnetic attraction. The iron can hat the magnetic attraction while the aluminum can doesn't have it. If the compressed can is the aluminum can, it will directly fall into the middle container 18b. And if it is the iron can, the electrified magnet 22 will attract it back to the front end of the receptacle 13. When the press shaft 21 touches the microswitch 24, the spindle 2 stops the action. Thus, the electrified magnet 22 doesn't have the magnetic attraction so that the iron can automatically falls into the left container 18a. The automatic sorting and compressing work is therefore completed as the flow chart is shown in FIG. 4.

In addition, both of the electrified poles 23a and 23b use the direct current whose voltage only amounts to approx. 6V. Thus, no danger is existing. In order to ensure the safety in using the present invention, the inner sides of the electrified poles 23a and 23b are fitted with insulation pieces 231. Accordingly, the main body 1 of the present invention is insulted and the leakage of electricity is reduced to the minimum.

Moreover, the reciprocating travel of the press shaft 21 of the commercially available spindle 2 can, of course, be prearranged. However, the volume of the recycled cans is different. When the travel of the press shaft 21 is fixed, the press shaft 21 easily breaks down because the press shaft 21 can be overloaded in compressing a larger or harder can. Therefore, the motor 20 which drives the press shaft 21 is in connection with a current-controlled device 201. This current-controlled device 201 can be the conventional amperemeter. When the current of the motor 20 is loaded to a certain extent, this means that the empty can is compressed by the press shaft 21 to such an extent that a greater counteracting force is created or an obstacle is encountered so that no further movement is possible. At this time, the motor 20 is reversibly moved back to the original position in order to prevent the spindle 2 from malfunction.

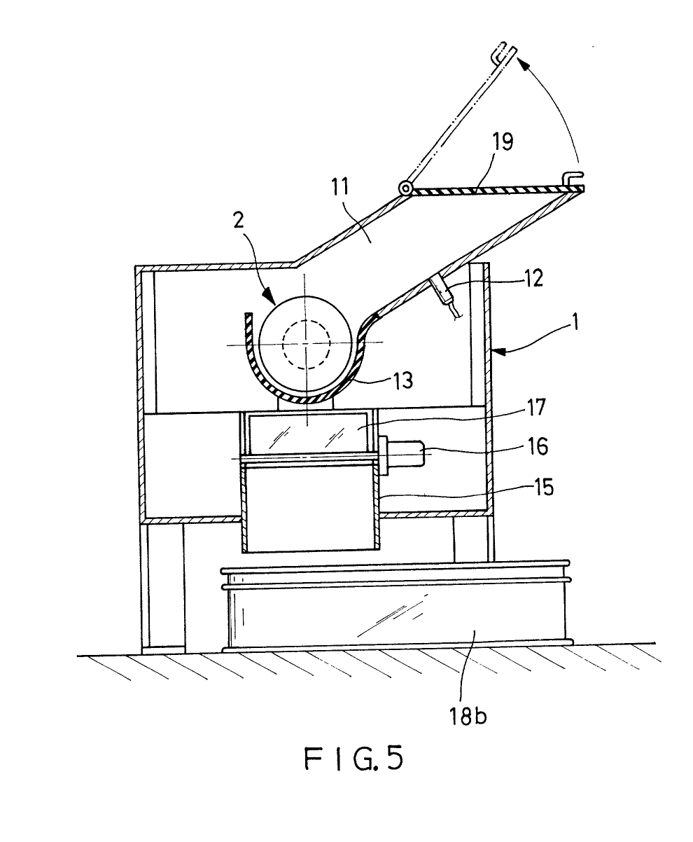

Accordingly, the present invention is able to compress and automatically sort the common cans (like iron, aluminum cans and plastic bottles). The sorting work and the storage room can therefore be significantly reduced to achieve the recycling effect. In order to enhance the safety in use, as shown in FIG. 5, a protecting cover19 is mounted to the inlet 11. Besides, the spindle 2 can only be actuated when the protecting cover19 is closed.

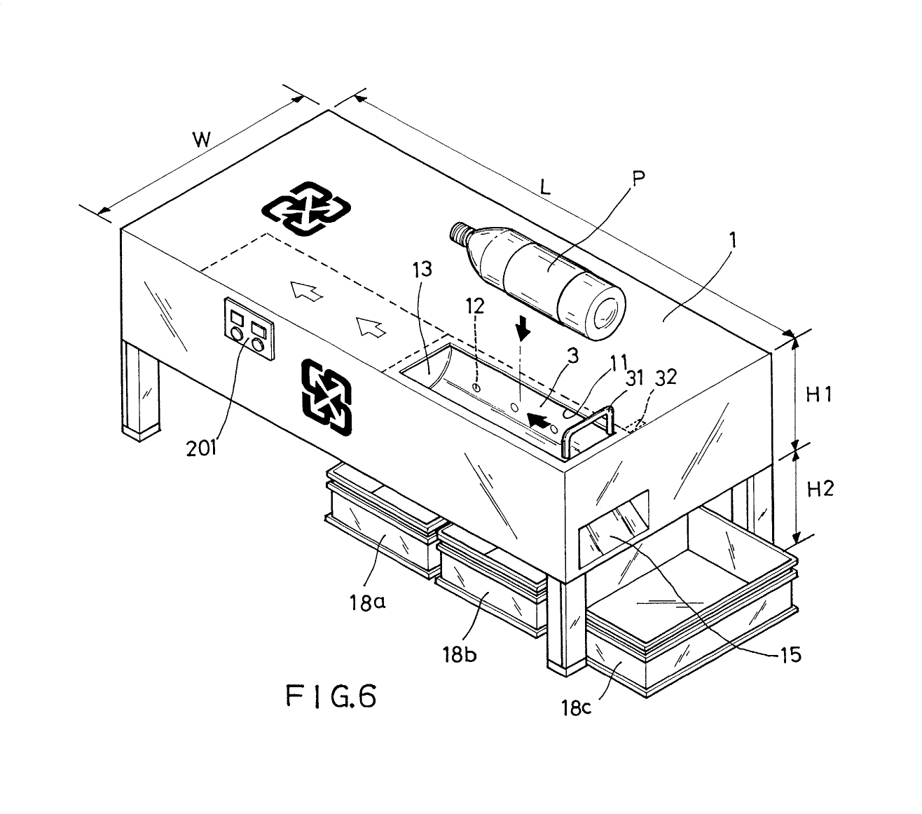

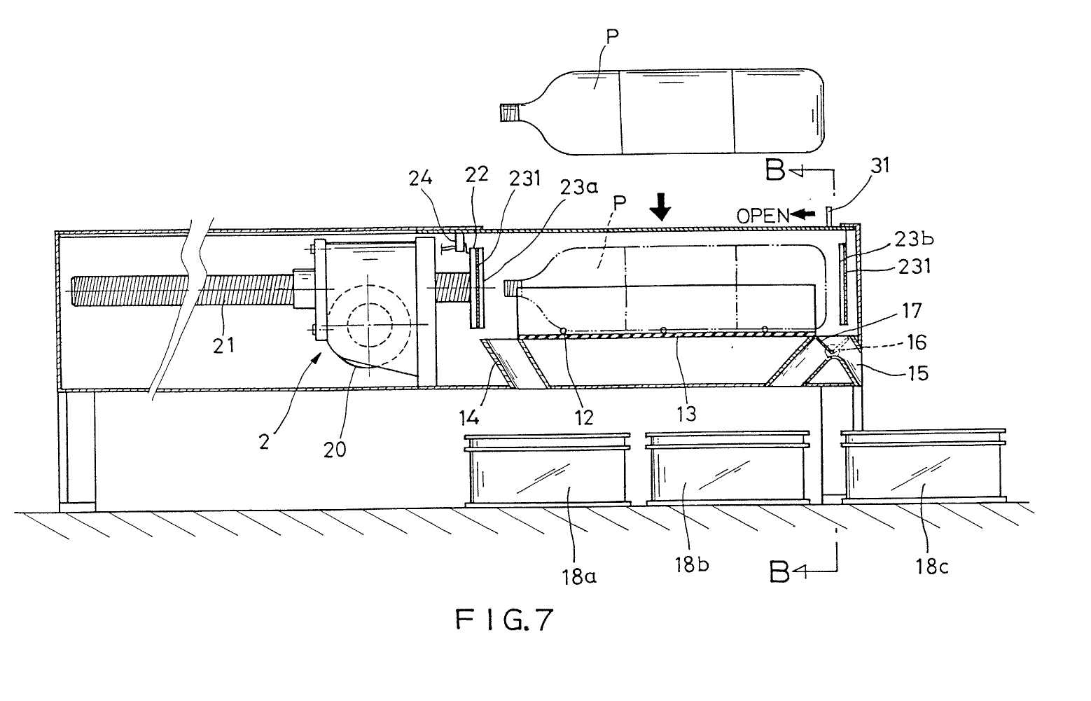

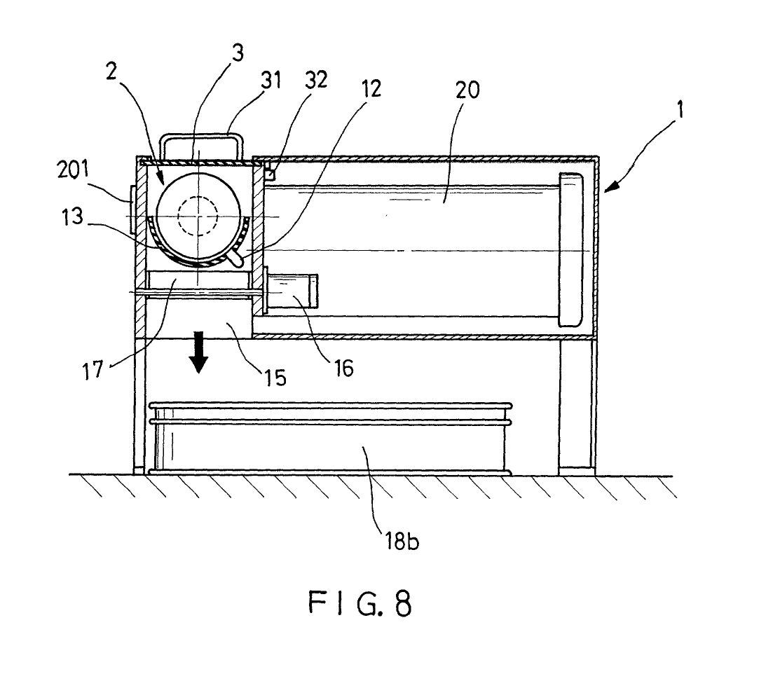

The motor 20 of the spindle 2 in the embodiment shown in FIGS. 1 through 5 is constructed in a vertical type. Besides, the inlet 11 projects slightly over the main body 1. This arrangement has its own advantages and meets requirements of some enterprises. However, the common stores need a small compression machine which has a faster compressing speed. To enhance the speed without reducing the torque of the motor, its horsepower must be increased so that the volume will be enlarged. In order to remove the above-mentioned drawbacks, a more efficient motor 20 of another embodiment of the present invention, as illustrated in FIGS. 6 through 8 is horizontally installed inside the main body 1. Therefore, the height (H1) of the main body 1 amounts only to 25 cm, plus the height (H2) of the feet, the overall height won't be more than 50 cm. And the width (W) amounts approx. to 45 cm and the length approx. 100 cm. The aforementioned dimensions of the automatic sorting compression machine suits the use of the common stores. The features of this embodiment are fully identical with that of the former embodiment and won't be described more hereinafter. The only difference is that the inlet 11 doesn't project over the main body 1 and has a laterally telescopic cover 3 for opening and closing the inlet 11. The cover 3 is made of transparent PVC and has a handle 31. Besides, a microswitch 32 is installed in the position corresponding to the closing position of the cover 3 and is actuated by the contact with the cover 3. When the empty can (P) is thrown into the inlet 11, the detecting switch 12 is touched. After the cover 3 is closed to touch the microswitch 32, the spindle 2 begins to move forward to perform the sorting and compressing tasks. Meanwhile, the operation can be observed through the transparent cover 3. If someone opens the cover 3, the microswitch 32 is released to stop the movement of the spindle 2 for ensuring the safety in use. Consequently, this kind of compression machine is more suitable for use in the public places,

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An automatic sorting compression machine for iron, aluminum cans and plastic bottles comprising:
a main body having an inlet at the top thereof, at least one detecting switch being arranged in a preset position of said inlet, a receptacle being disposed under said inlet, a one-way outlet and a two-way outlet being disposed under the front and rear ends of said receptacle, an exit selector controlled by a change-over magnetic valve being arranged at said two-way outlet, and a container is placed under each of the three channels of said outlets; and
a spindle having a press shaft passing through said receptacle, an electrified magnet and an electrified pole being disposed at the front end of said press shaft while another electrified pole opposite to the electrified pole is mounted in preset position of said main body, a microswitch being disposed in the farthest position of said press shaft being drawn back so that said detecting switch and said microswitch are used to start or stop the operation of said spindle.

2. An automatic sorting compression machine for iron, aluminum cans and plastic bottles as recited in claim 1, wherein the inner sides of said electrified poles are fitted with insulation pieces.

3. An automatic sorting compression machine for iron, aluminum cans and plastic bottles as recited in claim 1, wherein a protecting cover is mounted to said inlet, and wherein said spindle 2 can only be actuated when said protecting cover is closed.

4. An automatic sorting compression machine for iron, aluminum cans and plastic bottles as recited in claim 1, wherein a motor which drives said press shaft is in connection with a current-controlled device, and wherein said motor can be reversibly operated when the current of said motor is loaded up to a preset current value (ampere).

5. An automatic sorting compression machine for iron, aluminum cans and plastic bottles as recited in claim 1, wherein said inlet has a laterally telescopic cover.

6. An automatic sorting compression machine for iron, aluminum cans and plastic bottles as recited in claim 1, wherein said laterally telescopic cover is made of transparent PVC.

7. An automatic sorting compression machine for iron, aluminum cans and plastic bottles as recited in claim 1, wherein a microswitch is installed in the position corresponding to the closing position of said cover and is actuated by the contact with said cover.
